(19) United States
(12) Patent Application Publication
(10) Pub. No.: US 2011/0160940 A1
(43) Pub. Date: Jun. 30, 2011

(54) Text Flight Service Station

(76) Inventor: ROBERT M. SCHAPIRO, COLUMBIA, MD (US)

(21) Appl. No.: 12/944,120

(22) Filed: Nov. 11, 2010

Related U.S. Application Data
(60) Provisional application No. 61/290,077, filed on Dec. 24, 2009.

(51) Int. Cl. G06F 19/00; H04W 4/14

(52) U.S. Cl. 701/14

(57) ABSTRACT

A method and system (i.e. Text Flight Service Station) to provide up to date weather information, pilot information and flight plan information for small aircraft pilots, particularly, those flying at lower altitudes where radio information is limited or unavailable.

### FIELD

The invention disclosed herein generally relates to a method and system for conveying flight data to aircraft; and more particularly relates to transmitting and receiving flight related data for small aircraft.

### BACKGROUND

In small aircraft, which fly at low altitudes, it is typically difficult to obtain up-to-date weather in the cockpit. This is especially difficult below 1,000 feet MSL. A telephone weather briefing is available from Lockheed Martin Flight Service by calling 1-800-WX-BRIEF, however calling from inside the cockpit is challenging given the noisy environment and also the weak telephone coverage above 500 feet MSL.

There are some informational services available to pilots in the cockpit, one of which is a weather briefing via radio. However, radio coverage for these services below 5,000 feet MSL is exceedingly limited, whereby some aircraft are equipped with onboard weather services provided by satellite radio, called Datalink. Datalink, however, is far from typical or common in small aircraft.

### SUMMARY

Described herein is a method for communication of critical flight information in real-time using text messages, e.g. SMS texts or other short message formats as are known in the art. Critical flight information may include weather report, e.g. METAR, pilot reports, e.g. PIREPS and/or flight plan opening or closing information.

### DESCRIPTION OF THE DRAWINGS

FIG. 1 is a flow diagram of the present method.

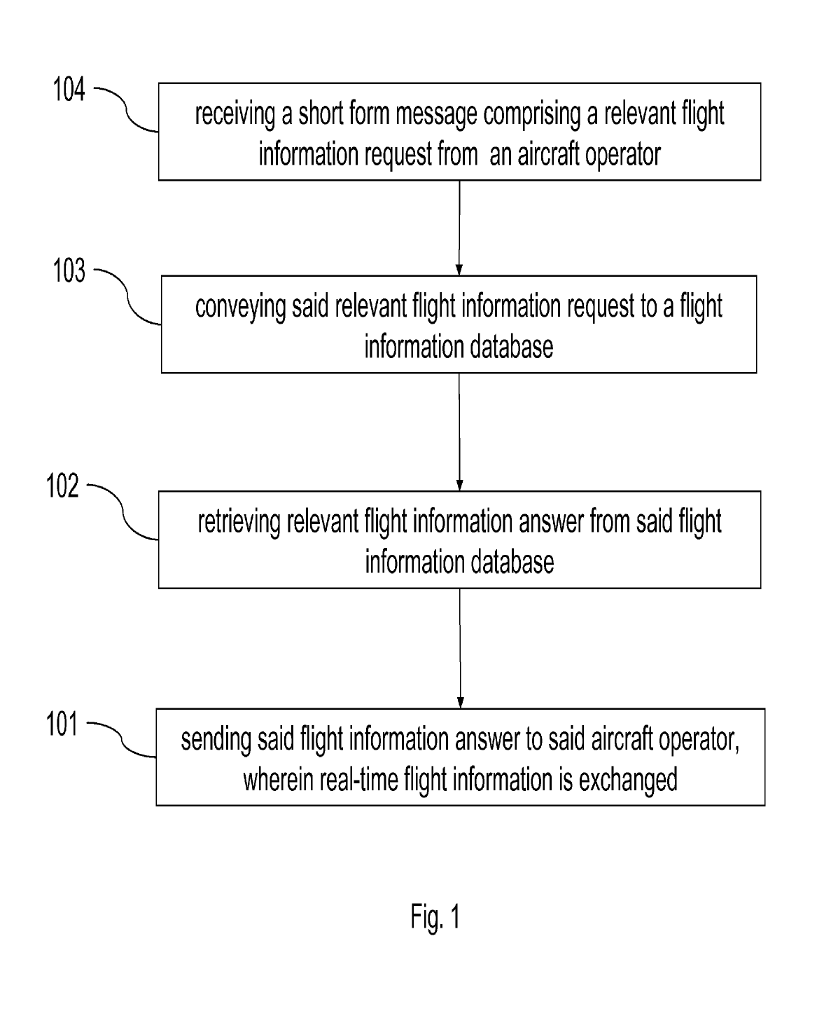

FIG. 2 illustrates a system architecture for the system.

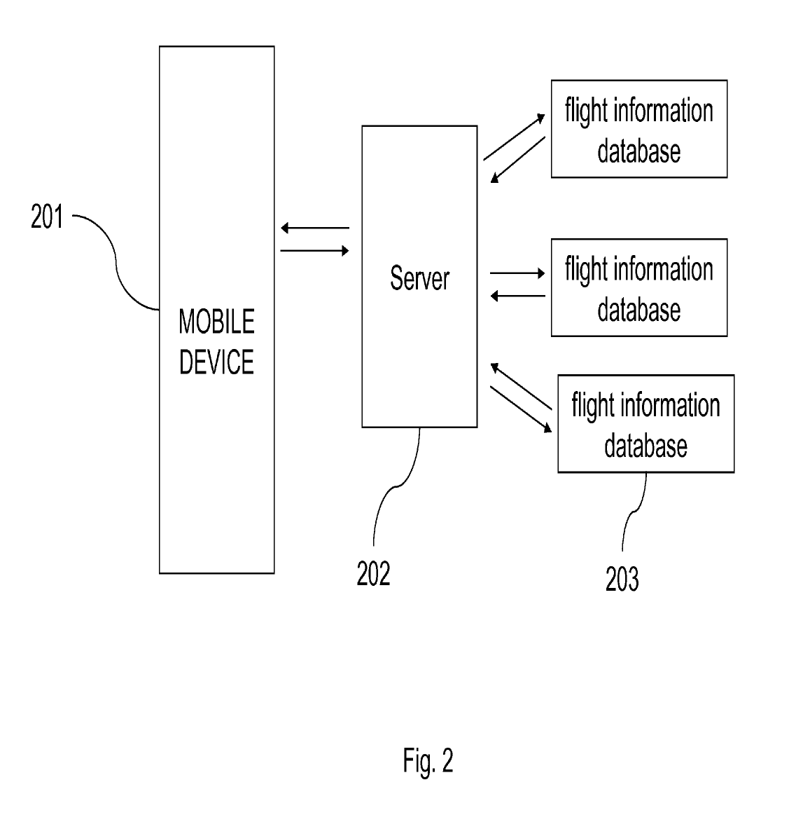

Having described generally the present invention and its objectives, the full scope of the present invention will be appreciated by those skilled in the art upon a review of the following detailed description of the preferred embodiment of the invention which is made in conjunction with the attached drawings. In the following description of the preferred embodiment of the invention, like numerals refer to like elements of the invention.

### DETAILED DESCRIPTION

Provided herein is a method and system for receiving a short form message (e.g. text message or SMS text) comprising a relevant flight information request from an aircraft operator (e.g. pilot, copilot, crew, etc.) (104); conveying the relevant flight information request to a flight information database (103); retrieving relevant flight information answer from the flight information database (102); and sending the flight information answer to the aircraft operator (101), wherein real-time flight information is exchanged. The relevant flight information request comprises weather information or other flight information as requested or necessitated by the aircraft operator.

The flight information database may comprise the National Oceanic and Atmospheric Administration (NOAA) weather information database or Lockheed Martin Flight Service Station weather information database.

The current invention further comprises placing the flight information answer in an outgoing queue, then processing the response to convey the flight information answer as the text to the aircraft operator.

The flight information request may comprise search-and-rescue flight-plan information; the information can be filed, opened and closed by a pilot.

The User Access Terminal (DUATS) or Lockheed Martin Flight Service Station's flight plan system may be used to process flight plan information. A confirmation of receipt of the flight information request can be sent using a test message to the aircraft operator.

The current invention further comprises receiving a text-message request from the pilot or another user on an aircraft requesting information from an information server via two-way text-messages wherein each request is placed in a queue, which is an incoming queue when the program checks the information server for requests, and an outgoing queue that is processed to send response to appropriate text message to a pilot or another user on an aircraft. The exchange of relevant flight information comprises email exchange of text messages. The flight information request can be placed in an incoming queue, and the current invention further comprises processing the flight information request and creating an outgoing queue of flight information answers.

In another embodiment, an error check for errors in weather or flight-plan requests and determines whether the requests are good or bad before further processing.

The flight information request includes the filing of any selected from the group consisting of: filing a new pilot report (PIREP); requesting a posted PIREP; a routine weather report (METARs); a terminal aerodrome forecast (TAFs); an area forecast (FAs); filing of a search and rescue flight plan; opening of a search and rescue flight plan; closing of a search and rescue flight plan an; or any combination thereof. Further, the flight information request includes filing, opening and closing the search-and-rescue flight plans via text-messaging. The flight information request and/or flight information answer is encoding using aviation weather teletype nomenclature described in the Aeronautical Information Manual.

As discussed herein, this method and system disclosure (i.e. Text Flight Service Station) provides up to date weather information, pilot information and flight plan information for small aircraft pilots, particularly, those flying at lower altitudes where radio information is limited or unavailable. Typically, there are weather reports, specifically designed for pilots called routine weather reports (METARs), terminal aerodrome forecasts (TAFs), area forecasts (FAs), and pilot reports (PIREPs). These are all encoded using minimal characters, for example: KBWI 201954Z 26008KT 10SM FEW090 SCT150 BKN200 21/01 A3014 RMK A02 SLP207 T02110011. These minimal character encoded message reads as follows: “at BWI airport, on the 20th day of the month, a report was taken at 19:54 Zulu (15:54 EDT). Winds are from 260 degrees at 08 knots. Visibility 10 statute miles. Few clouds at 9,000 ft. AGL. Scattered clouds at 15,000 ft. AGL. Broken clouds at 20,000 ft. AGL. Temperature 21 degrees Celsius. Dewpoint 01 degree Celsius. Barometric pressure 30.14 inches of mercury.”

It is an embodiment, to provide a method for checking weather when the engine of the aircraft is running, making cellular phone weather inquiries impossible. The method provides for checking weather via mobile device, such mobile devices include cellular telephone, personal data assistants (PDAs), smartphones, and other devices as are known in the art. The present method provide for checking weather and other flight information without shutting down the aircraft or climbing to an altitude above about 5,000 feed to check weather via radio.

It is a further embodiment of the present invention to provide for the filing, opening, and closing flight plans. Often times while making long distance flights, pilots of small aircrafts will voluntarily file “search and rescue” flight plans. Typically, these flight plans are opened prior to or immediately after departure and closed upon arrival at the destination. If the pilot does not make a telephone call and close the flight plan within 30 minutes of the scheduled arrival time, Lockheed Martin Flight Service Stations will initiate a search and rescue protocol in attempt to find the missing aircraft. Small aircraft pilots usually fly at altitudes, below radio coverage, making it difficult or impossible to call up the flight service stations. If small aircraft pilots are running 30 minutes or more behind schedule, they may not be in a position, due to altitude and/or terrain, to amend the flight plan via radio. And, if they arrive more than 30 minutes late, they may cause search and rescue efforts to be initiated unnecessarily. As a result, many pilots don't file these flight plans and many more face legal and financial repercussions if they run late. The present method provides a means for updating flight plans mid-flight and the ability to open and close such plans via text message.

It is a further embodiment of the method to provide for the filing of pilot reports (PIREP). A PIREP is one type of weather reports filed by pilots for pilots. They let other pilots know of hazards to flight including but not limited to icing, thunderstorms, severe wind, and instrument meteorological conditions that are experienced during the course of a flight. Presently, in order for a pilot to file these PIREPs, they must call a weather briefer (1-800-WX-BRIEF) upon landing, wait on hold, talk to the briefer, and give the appropriate information. It also doesn't allow real-time information because these phone calls are often made after landing. The PIREP may be filed from the air via radio, but again, radio coverage is spotty at low altitudes. Therefore, the present method provides for conveying PIREPs mid-flight via text message which improves passenger and pilot safety.

It is yet another embodiment of the method and system to provide a Text Flight Service Station. Currently, the software that was designed and written in this invention receives SMS text messages and processes requests. It responds with all of the following weather reports as requested: METAR, TAF, FA, and PIREP. This will allow pilots to stay better up to date with weather at their destination airports.

This invention provides for allowing the pilots to file, open, and close the search and rescue flight plans via SMS text messages. This will significantly reduce the cost of search and rescue efforts from unclosed flight plans as well as encourage more pilots to file them. With cooperation of Lockheed Martin Flight Service Stations, this invention can to implement a third feature that would allow pilots to file PIREPs using SMS text messages as well. This will encourage more pilots to file PIREPs on every flight.

Detailed Description of Text Flight Service Station. Text Flight Service Station is a lightweight software application that can run on almost any PC. The program is written entirely in Microsoft Visual Basic.NET. It utilizes e-mail as a method for exchanging text messages. The pilot sends a text message to wx@txtfss.com. Text Flight Service Station routinely checks the e-mail server for requests. Each request is stored in an incoming queue. Another process checks the incoming queue for requests. If the request is bad, the program places an error message in the outgoing queue. If the request is good, it is processed based on the type. If it is a request for weather, the program uses the NOAA website to obtain the weather report and places it in the outgoing queue. The outgoing queue is then processed to send the response to the appropriate text message.

If the request is flight plan related, the program will make the appropriate request using Direct User Access Terminal (DUATS). A confirmation will be placed in the outgoing queue to notify the pilot that the request has been processed. If the request involves filing a PIREP, with Lockheed Martin Flight Service Station's cooperation, the program will file the PIREP into the system just as if it were entered by a flight briefer. The program currently does all of the necessary error checking for weather requests. Once the features are implemented, it will do the same for flight plan requests filing PIREP requests. The program will use short codes to receive texts as well. This will allow pilots to send text messages to simple five-digit numbers rather than an e-mail address. It is an embodiment of the invention to provide a Text Flight Service Station system and method comprising: receiving a short form message comprising a relevant flight information request from an aircraft operator; conveying the relevant flight information request to a flight information database; processing the request based on the information stored in the database; storing the requested information back in the database; retrieving requested information from the flight information database; and sending the requested information to the aircraft operator, wherein real-time flight information is exchanged. The relevant flight information request comprises weather information, flight plan information, or pilot reports.

It is a further embodiment of the invention to interface directly with Lockheed Martin flight service station computers to more immediately retrieve weather information than via HTTP requests with the National Oceanic and Atmospheric Administration (NOAA) website. The direct interface will provide for more reliable filing, opening, and closing of flight plans and filing pilot reports.

The method and system further comprises of using Direct User Access Terminal (DUATS) is used to file, open, and close flight plans. The method and system can further provide for a confirmation of receipt of the flight plan filing, opening, or closing and the confirmation to the aircraft operator.

The method further comprises receiving a text-message request from the pilot or another user on an aircraft requesting information from an information server via two-way text-messages wherein each request is placed in a queue, which is an incoming queue when the program checks the information server for requests, and an outgoing queue that is processed to send response to appropriate text message to a pilot or another user on an aircraft. The exchange of relevant flight information comprises email exchange of text messages. The flight information request may be placed in an incoming queue, is processed, and an outgoing queue of flight information answers is created.

The method and system may further include a mechanism for error checking for mistakes or inconsistencies in weather or flight-plan requests and determines whether the requests are good or bad before further processing.

The flight information request includes the filing of any selected from the group consisting of: filing a new pilot report (PIREP); requesting a posted PIREP; a routine weather report (METARs); a terminal aerodrome forecast (TAFs); an area forecast (FA); filing of a search and rescue flight plan; opening of a search and rescue flight plan; closing of a search and rescue flight plan an; or any combination thereof. Additionally, the flight information request includes filing, opening and closing the search-and-rescue flight plans via text-messaging. The flight information request and/or the flight information answer is encoding using aviation weather teletype nomenclature as described in the Aeronautical Information Manual.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

Each of the applications and patents cited in this text, as well as each document or reference, patient or non-patient literature, cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference in their entirety. More generally, documents or references are cited in this text, either in a Reference List before the claims; or in the text itself; and, each of these documents or references (“herein-cited references”), as well as each document or reference cited in each of the herein-cited references (including any manufacturer's specifications, instructions, etc.), is hereby expressly incorporated herein by reference.

1. A Text Flight Service Station system and method comprising:
receiving a short form message comprising a relevant flight information request from an aircraft operator; conveying the relevant flight information request to a flight information database; retrieving relevant flight information answer from the flight information database; and sending the flight information answer to the aircraft operator, wherein real-time flight information is exchanged.

2. The system and method according to claim 1, wherein the relevant flight information request comprises weather information.

3. The system and method according to claim 1, wherein the flight information database comprises the National Oceanic and Atmospheric Administration (NOAA) weather information database or Lockheed Martin Flight Service Station weather information database.

4. The system and method according to claim 1, further comprises placing the flight information answer in an outgoing queue, then processing the response to convey the flight information answer as the text to the aircraft operator.

5. The method and system according to claim 1, wherein the flight information request comprising search-and-rescue flight-plan information; the information can be filed, opened and closed by a pilot.

6. The method and system according to claim 1, wherein User Access Terminal (DUATS) or Lockheed Martin Flight Service Station's flight plan system is used to process flight plan information.

7. The method and system according to claim 1, wherein a confirmation of receipt of the flight information request is sent using a test message to the aircraft operator.

8. The method in claim 1 further comprising receiving a text-message request from the pilot or another user on an aircraft requesting information from an information server via two-way text-messages wherein each request is placed in a queue, which is an incoming queue when the program checks the information server for requests, and an outgoing queue that is processed to send response to appropriate text message to a pilot or another user on an aircraft.

9. The method and system according to claim 1, wherein the exchange of relevant flight information comprises email exchange of text messages.

10. The method and system according to claim 1, wherein the flight information request is placed in an incoming queue.

11. The method and system according to claim 8, further comprises processing the flight information request and creating an outgoing queue of flight information answers.

12. The method and system according to claim 1, wherein an error check for errors in weather or flight-plan requests and determines whether the requests are good or bad before further processing.

13. The method and system according to claim 1, wherein the flight information request includes the filing of any selected from the group consisting of: filing a new pilot report (PIREP); requesting a posted PIREP; a routine weather report (METARs); a terminal aerodrome forecast (TAFs); an area forecast (FAs); filing of a search and rescue flight plan; opening of a search and rescue flight plan; closing of a search and rescue flight plan an; or any combination thereof.

14. The method and system according to claim 1, wherein the flight information request includes filing, opening and closing the search-and-rescue flight plans via text-messaging.

15. The method and system according to claim when wherein the flight information request and/or the flight information answer is encoding using aviation weather teletype nomenclature described in the Aeronautical Information Manual.
